(19) United States
(12) Patent Application Publication
(10) Pub. No.: US 2007/0109269 A1
(43) Pub. Date: May 17, 2007

(54) Input system with light source shared by multiple input detecting optical sensors

(76) Inventor: David C. Feldmeler, Redwood City, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/274,521

(22) Filed: Nov. 15, 2005

(51) Int. Cl. G09G 5/08

(52) U.S. Cl. 345/166

(57) ABSTRACT

In one aspect, an input system includes a light source, a first optical sensor, a second optical sensor, and a processing system. The light source illuminates a first scene that changes in response to a first type of user input and a second scene that changes in response to a second type of user input. The first optical sensor has a first field of view of the first scene and produces first electrical signals in response to light from the light source in the first field of view. The second optical sensor has a second field of view of the second scene and produces second electrical signals in response to light from the light source in the second field of view. The processing system respectively produces first and second user interface control signals from the first and second electrical signals.

### BACKGROUND

Many different types of input devices have been developed for inputting commands into a machine. For example, hand-manipulated input devices, such computer mice, joysticks, trackballs, touchpads, and keyboards, commonly are used to input instructions into a computer by manipulating the input device. Such input devices allow a user to control movement of a virtual pointer, such as a cursor, across a computer screen, select or move an icon or other virtual object displayed on the computer screen, and open and close menu items corresponding to different input commands. Input devices commonly are used in both desktop computer systems and portable computing systems.

Input devices typically include a mechanism for converting a user input into user interface control signals, such as cursor position data and scrolling position and distance data. Some types of input devices use electromechanical transducers to convert user manipulations of the input device into electrical signals that can be converted into user interface control signals. Other types of input devices use optoelectronic transducers to convert user manipulations of the input device into user interface control signals. Optoelectronic transducer based input devices tend to have improved resistance to degradation by contamination and wear relative to electromechanical transducer based input devices. Optoelectronic transducers, however, tend to require significantly more power than electromechanical transducers, which a significant factor in the design of wireless input devices that communicate with host computer systems over a wireless connection and draw power from a portable power source, such as a battery.

Although power management techniques typically are used to increase the efficiency with which power is used in optoelectronic transducer based input devices, additional ways to reduce the power requirements of optoelectronic transducer based input devices are needed.

### SUMMARY

In one aspect, the invention features an input system that includes a light source, a first optical sensor, a second optical sensor, and a processing system. The light source illuminates a first scene that changes in response to a first user input and a second scene that changes in response to a second user input. The first optical sensor has a first field of view of the first scene and produces first electrical signals in response to light from the light source in the first field of view. The second optical sensor has a second field of view of the second scene and produces second electrical signals in response to light from the light source in the second field of view. The processing system respectively produces first and second user interface control signals from the first and second electrical signals.

In another aspect, the invention features an input method in accordance with which light is produced from a source illuminating a first scene that changes in response to a first user input and a second scene that changes in response to a second user input. First electrical signals are produced in response to the light illuminating the first scene in a first field of view. Second electrical signals are produced in response to the light illuminating the second scene in a second field of view. First and second user interface control signals are respectively produced from the first and second electrical signals.

Other features and advantages of the invention will become apparent from the following description, including the drawings and the claims.

### DESCRIPTION OF DRAWINGS

FIG. 1 is a block diagram of an embodiment of an input device.

FIG. 2 is a flow diagram of an embodiment of a method implemented by the input device shown in FIG. 1.

FIG. 3 is a block diagram of an embodiment of the input device shown in FIG. 1.

FIG. 4 is a block diagram of an embodiment of the input device shown in FIG. 1.

FIG. 5 is a perspective view of a housing containing an embodiment of the input device shown in FIG. 4.

FIG. 6 is a perspective view of the input device embodiment shown in FIG. 5 with the top portion of the housing removed.

FIG. 7 is a schematic view of an encoder and an embodiment of a first optical sensor in an embodiment of the input device shown in FIG. 4.

FIG. 8 is a block diagram of an embodiment of the input device shown in FIG. 1.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

The embodiments that are described in detail below reduce the power requirements of input devices that use optoelectronic transducers to convert user manipulations into user interface control signals by sharing the light generated by a light source among multiple input detecting optical sensors. In addition to reducing power requirements, these embodiments reduce costs relative to input devices that have a respective light source for each of multiple input detecting optical sensors.

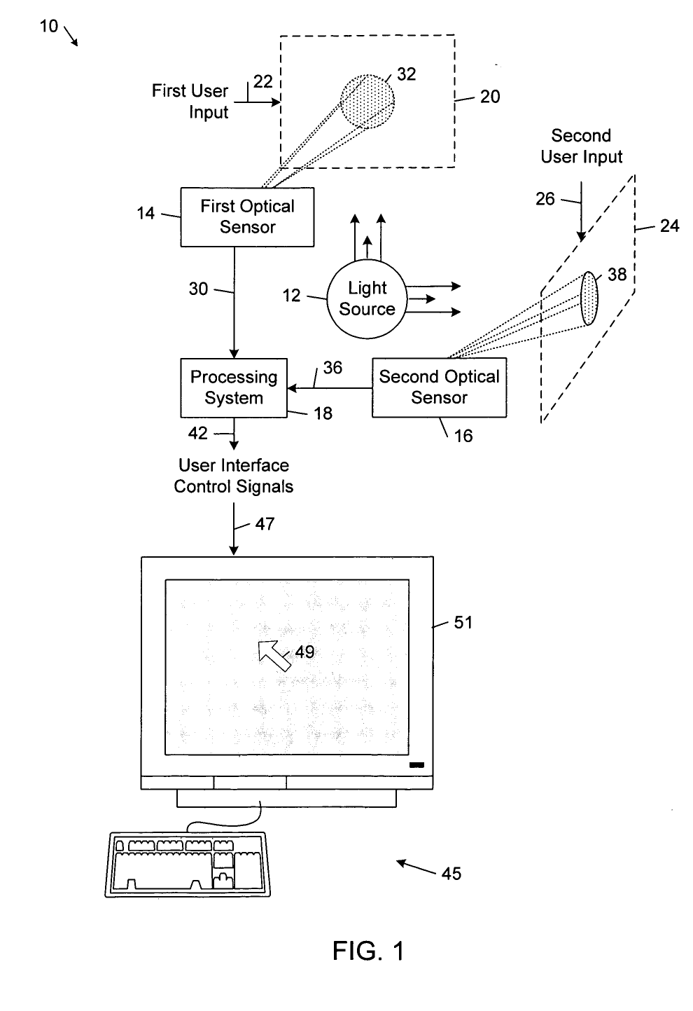

FIG. 1 shows an embodiment of an input device 10 that includes a light source 12, a first optical sensor 14, a second optical sensor 16, and a processing system 18. The input device 10 may be incorporated into any type of input device form factor, including a computer mouse, a joystick, a trackball, and a steering wheel controller.

The light source 12 may be any type of light source that is capable generating light that can be sensed by the first and second optical sensors 14, 16. In some embodiments, the light source 12 is implemented by a light emitting diode that is capable of producing light within a specified wavelength range that is detectable by the first and second optical sensors 14, 16. The specified wavelength range typically is within the visible light spectrum or within the infrared light spectrum.

The first and second optical sensors 14, 16 may be any type of optical sensors that are capable of optically sensing user manipulations of a component of the input device 10 (e.g., a touch pad, a trackball, or a joystick) or manipulations of the input device 10 itself (e.g., movement of the input device 10 across a surface or through the air). The first and second optical sensors 14, 16 may include one or more of any type of photodetector device, including a single photosensor, a one-dimensional optical detector (e.g., a linear array of photodiodes), and a two-dimensional optical detector (e.g., a CCD or CMOS image sensor device). In some embodiments, the first and second optical sensors 14, 16 correspond to different respective parts of a single optical device. For example, in some of these embodiments, the first and second optical sensors 14, 16 correspond to non-overlapping regions of an array of optical detectors.

The processing system 16 may be implemented by one or more discrete modules that are not limited to any particular hardware or software configuration. The one or more modules may be implemented in any computing or processing environment, including in digital electronic circuitry (e.g., an application-specific integrated circuit, such as a digital signal processor (DSP)) or in computer hardware, firmware, device driver, or software.

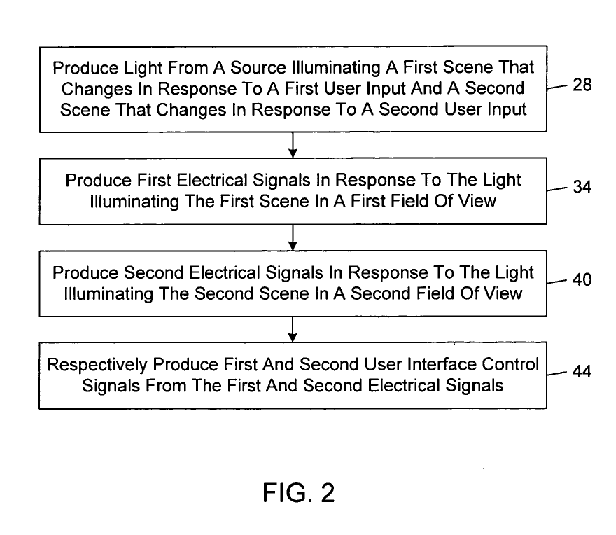

FIG. 2 shows a flow diagram of an embodiment of a method that is implemented by the input device 10. In accordance with this method, the light source 12 illuminates a first scene 20 that changes in response to a first user input 22 and a second scene 24 that changes in response to a second user input 26 (FIG. 2, block 28). In general, the first and second scenes 20, 24 are changed independently of one another (e.g., the first user input 22 changes the first scene 20 without changing the second scene 24, and the second user input 26 changes the second scene 24 without changing the first scene 20). The first and second user inputs 22, 26 may be the same type of user input (for example: manipulation of a movable member, such as a rotatable wheel, a slidable slider, a rotatable ball, a movable stylus, or a movable stick first; and manipulation of the entire input device 10) or they may be different types of user input (e.g., manipulation of a movable member and manipulation of the entire input device 10 across a surface).

The first optical sensor 14 produces first electrical signals 30 in response to the light illuminating the first scene 20 in a first field of view 32 (FIG. 2, block 34). The first field of view 32 corresponds to the area of the first scene 20 that is visible to the active light-sensing elements of the first optical sensor 14. The second optical sensor 16 produces second electrical signals 36 in response to the light illuminating the second scene 24 in a second field of view 38 (FIG. 2, block 40). The second field of view 38 corresponds to the area of the second scene 24 that is visible to the active light-sensing elements of the second optical sensor 16. The processes of blocks 34 and 40 may be performed sequentially or concurrently.

The processing system 18 respectively produces first and second user interface control signals 42 from the first and second electrical signals 30, 36 (FIG. 2, block 44). Examples of the types of user interface control signals that may be produced by the processing system 18 include cursor position and movement data and scrolling position and distance data. In the embodiment shown in FIG. 1, the first and second user interface control signals 42 are transmitted to a computer 45 over a communication link 47 (e.g., a serial communication link, such as an RS-232 serial port, a universal serial bus, or a PS/2 port). In operation, the computer 45 executes a driver in an operating system or an application program that processes the first and second user interface control signals to control the display and movement of a pointer 49 on a computer monitor 51.

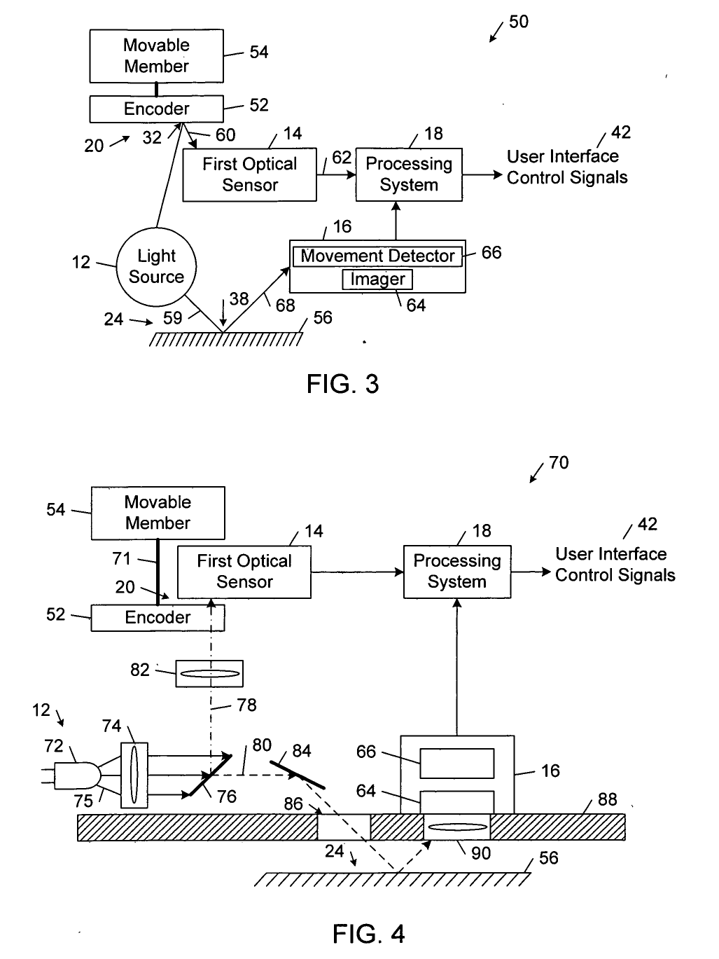

FIG. 3 shows a block diagram of an input device 50 that is an embodiment of the input device 10. In the input device 50, the first scene 20 is a surface of an encoder 52, which is mechanically connected to a movable member 54, and the second scene 24 is a surface 56 with respect to which the input device 50 may be moved by a user. The light source 12 illuminates the first and second scenes 20, 24 with light 58, 59. The light source 12 may include one or more optical elements for guiding and shaping the light 58, 59 that illuminates the first and second scenes 20, 24.

The movable member 52 may include a rotatable wheel, a slidable slider, a rotatable ball, a movable stylus, a movable stick, or a movable button (e.g., a right or left computer mouse button), depending on the target application for the input device 50. The encoder 52 may be connected to the movable member 54 by a separate and distinct element, such as a rotatable shaft, or the encoder 52 may be attached to or formed on a surface of the movable member 54.

The encoder 52 modulates light 60 from the light source 12 in the first field of view 32 with information that encodes movement of the movable member 54. In general, the encoder 52 may be implemented by any type of device that is capable of modulating the light 60 with position encoding information. In some embodiments, the encoder 52 includes a coded pattern of light modulating regions, where the position of the coded pattern in the first field of view 32 changes with movement of the movable member 54. In the embodiment shown in FIG. 3, the encoder 52 includes a coded pattern of regions having different light reflectivity. The regions of different reflectivity may correspond to reflective regions and non-reflective regions (e.g., absorptive regions or translucent regions).

In some implementations, the first optical sensor 14 produces an electrical signal 62 that tracks the intensity of the light 60 that is modulated by the encoder 52. The electrical signal 62 includes peaks at the times when the reflective regions of the encoder 52 are in the first field of view 32 and valleys at the times when the non-reflective regions of the encoder 52 are in the first field of view 32. The processing system 18 determines the position of the encoder 52 from the peaks and valleys in the electrical signal 62.

In other implementations, the first optical sensor 14 includes two optical detectors each of which produces a respective electrical signal from the modulated light 60 reflecting from a different region in the first field of view 32. In these implementations, the coded pattern of the encoder 52 and the respective fields of view of the optical detectors are configured so that the electrical signals produced by the optical detectors are in quadrature (i.e., out of phase, e.g., by 90°). The processing system 18 determines the position and direction of motion of the encoder 52 from the quadrature electrical signals using quadrature signal processing techniques and translates the determined motion into user interface control signals 42.

In some embodiments, the second optical sensor 16 corresponds to an optical navigation sensor module that includes an imager 64 and a movement detector 66. The imager 64 may be any form of imaging device that is capable of capturing one-dimensional or two-dimensional images of the surface 56. The imager 64 includes at least one image sensor. Exemplary image sensors include one-dimensional and two-dimensional CMOS (Complimentary Metal-Oxide Semiconductor) image sensors and CCD (Charge-Coupled Device) image sensors. The imager 64 captures images at a rate (e.g., 1500 pictures or frames per second) that is fast enough so that sequential pictures of the surface 56 overlap. The imager 64 may include one or more optical elements that focus light 68 from the light source 12 that reflects from the surface 56 onto the one or more image sensors.

The movement detector 66 may be part of the processing system 18 or it may be part of the second optical sensor 16 as shown in FIG. 3. The movement detector 66 is not limited to any particular hardware or software configuration, but rather it may be implemented in any computing or processing environment, including in digital electronic circuitry or in computer hardware, firmware, or software. In one implementation, the movement detector 66 includes a digital signal processor (DSP). The movement detector 66 detects relative movement between the input device 50 and the surface 56 based on comparisons between images of the surface 56 that are captured by the imager 64. In particular, the movement detector 66 identifies texture or other features in the images and tracks the motion of such features across multiple images. These features may be, for example, inherent to the surface 56, relief patterns embossed on the surface 56, or marking patterns printed on the surface 56. The movement detector 66 identifies common features in sequential images and determines the direction and distance by which the identified common features are shifted or displaced.

In some implementations, the movement detector 66 correlates features identified in successive images to provide information relating to the position of the surface 56 relative to the imager 64. In general, any type of correlation method may be used to track the positions of features across successive images. In some embodiments, a sum of squared differences correlation method is used to find the locations of identical features in successive images in order to determine the displacements of the features across the images. In some of these embodiments, the displacements are summed or integrated over a number of images. The resulting integration values may be scaled to compensate for any image scaling by the optics associated with the imager 64. The movement detector 66 translates the displacement information into two-dimensional relative motion vectors (e.g., X and Y motion vectors) that describe the relative movement of the input device 50 across the surface 56. The processing system 18 produces the user interface control signals 42 from the two-dimensional motion vectors.

Additional details relating to the image processing and correlating methods that are performed by the movement detector 66 can be found in U.S. Pat. Nos. 5,578,813, 5,644,139, 5,703,353, 5,729,008, 5,769,384, 5,825,044, 5,900,625, 6,005,681, 6,037,643, 6,049,338, 6,249,360, 6,259,826, 6,233,368, and 6,927,758. In some embodiments, the imager 64 and the movement detector 66 may be implemented by an optical mouse navigation sensor module (e.g., the ADNS-2051 optical mouse navigation sensor available from Agilent Technologies, Inc. of Palo Alto, Calif., U.S.A.).

FIG. 4 shows a block diagram of an input device 70 that is an embodiment of the input device 10. The input device 70 is similar to the input device 50 that is shown in FIG. 3, except that the first optical sensor 14 is located between the encoder 52 and the movable member 54 and the input device 70 includes optical elements (e.g., one or more refractive optical elements, diffractive optical elements, light pipes, and optical waveguides) for guiding and shaping the light from the light source 12 that illuminates the first and second scenes and an optical element for focusing the light reflecting from the surface 56 onto the active regions of the imager 64.

In this embodiment, the encoder 52 is connected to the movable member 54 by a rotatable shaft 71. The encoder 52 includes a coded pattern of opaque and translucent regions. The first optical sensor 14 has a field of view of the modulated light from the light source 12 that is transmitted through the translucent regions of the encoder 52.

In the input device 70, the light source 12 is implemented by a light emitting diode 72 and an optical element 74 that collimates the light 75 that is produced by the light emitting diode 72. A beam splitter 76 (e.g., a plate beam splitter, a cube beam splitter, a pellicle beam splitter, or a perforated beam splitter) divides the collimated light into a first beam 78 and a second beam 80. The first beam 78 is directed to an optical element 82 (e.g., a lens), which focuses the first beam 78 onto the encoded light-modulating pattern of the encoder 52. The second beam 80 is directed to an optical element 84 (e.g., a mirror) that directs the second beam 80 to the surface 56 through an optical port 86 that is formed in an exterior wall 88 of the input device 70. A portion of the second beam 80 that reflects from the surface 56 is focused by an optical element 90 onto the active areas of the imager 64.

FIG. 5 shows a perspective view of an embodiment of a housing 100 that contains an embodiment of the input device 70. The housing 100 includes a base 102 and a top portion 104. The housing 100 also includes a right input button 106, a left input button 108, and an opening 110 through which the movable member 54 extends. In this embodiment, the movable member 54 is implemented by a rotatable wheel 112 (e.g., a Z-axis control wheel or a Z-wheel).

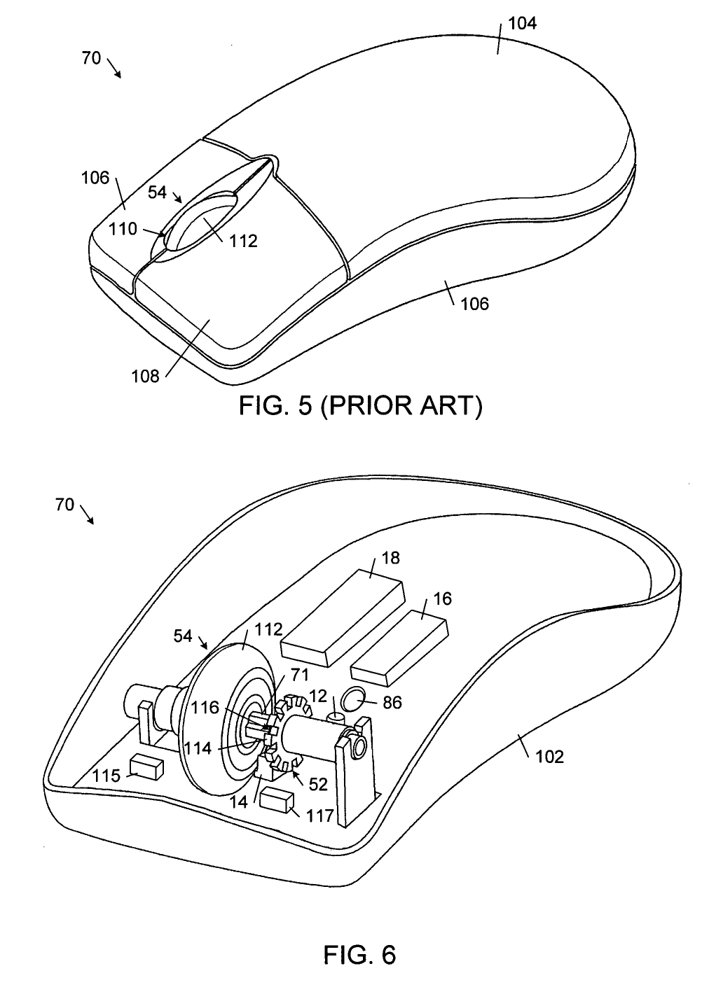

FIG. 6 is a perspective view of the input device embodiment shown in FIG. 5 with the top portion of the housing 100 removed. For clarity of presentation, the optical elements 74, 76, 82, and 84 are not shown in FIG. 6. The movable member 54 and the encoder 52 are mounted on the shared rotatable shaft 71. The encoder 52 is implemented by a prior art code disk that includes a set of equally spaced teeth 114 and a set of slots 116 that are formed between adjacent ones of the teeth. In other embodiments, the encoder 52 may be implemented by a translucent disk that includes a radially spaced pattern of grating lines. Right and left switches 115, 117 are used to detect when a user has activated the right and left input buttons 106, 108, respectively.

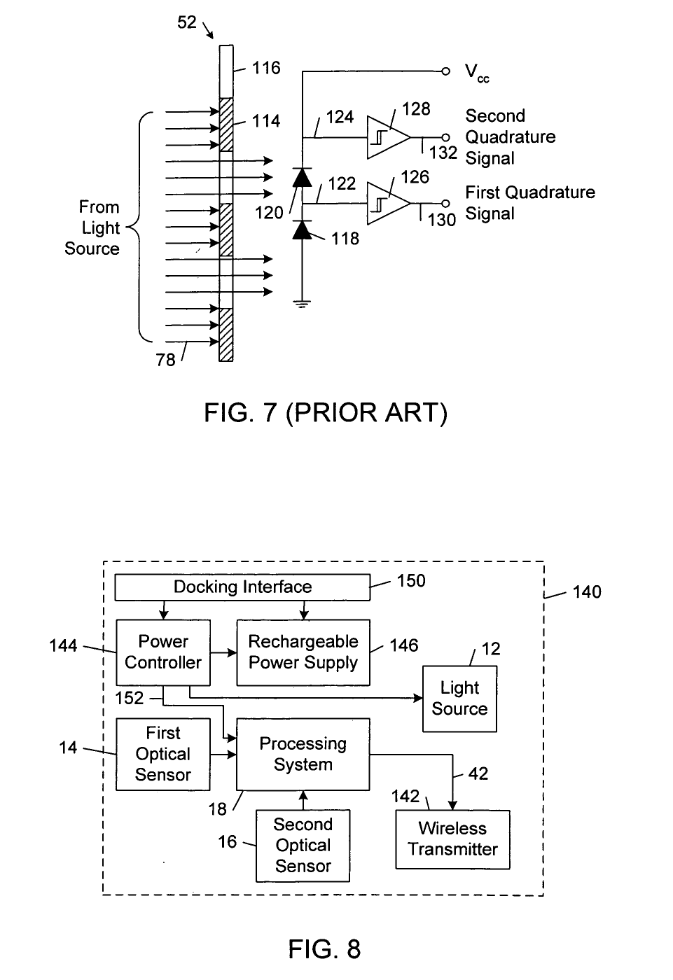

FIG. 7 shows a schematic view of the prior art code disk implementation of the encoder 52 and a prior art implementation of the first optical sensor 14 that includes a first optical detector 118 and a second optical detector 120. The first and second optical detectors 118, 120 typically are implemented by photodiodes. In operation, the code disk rotates when the wheel 112 is rotated by a user. The light 78 from the light source 12 is blocked by the teeth 114 of the code disk as they rotate into position in front of the respective fields of view of the first and second optical detectors 118, 120. The first and second optical detectors 118, 120 are configured with respect to the pattern of teeth 114 and slots 116 of the code disk so that they produce output electrical signals 122, 124 in quadrature. Thus, when the code disk is rotated at a constant rate, the first and second optical detectors 118, 120 respectively produce electrical signals that vary sinusoidally and are 90° out of phase. The output electrical signals 122, 124 are passed to first and second Schmitt triggers 126, 128, which reduce noise in the output electrical signals 122, 124. The processing system 18 processes the resulting first and s second quadrature signals 130, 132 to determine the motion of the encoder 52.

FIG. 8 is a block diagram of an input device 140 that is an embodiment of the input device 10. In addition to the first and second optical sensors 14, 16 and the processing system 18, the input device 140 includes a wireless transmitter 142, a power controller 144, a rechargeable power supply 146, and a docking interface 150. The processing system 18 delivers the user interface control signals 42 to the wireless transmitter 142 in a format that is suitable for reception by a host computer system. The wireless transmitter 142 may be implemented by any one of a wide variety of different wireless transmitters, including an RF transmitter and an IR transmitter. The rechargeable power supply 146 may be any type of battery or other electrical power store that can be recharged by an external power source through the docking interface 150. The power controller 144 controls the supplying of power from the rechargeable power supply 146. In some embodiments, the power controller 144 is part of the processing system 18 instead of a separate component as shown in FIG. 8.

In general, the power controller 144 may implement any one of a wide variety of different power management algorithms. In some embodiments, when the input device 140 has not received any input from a user for a specified period the power controller 144 changes the input device 140 from an active power mode (or full power mode) to a standby or idle mode, during which the light source 12 is turned off. The power controller 144 transmits to the processing system 18 a power mode status signal 152, which has a variable value that indicates the current power mode of the input device 140. In these embodiments, the processing system 18 selectively processes the electrical signals produced by the first and second optical sensors 14, 16 into the user interface control signals 42 in response to the value of the power mode status signal 152. In particular, when the input device 140 is in the active power mode, the processing system 18 processes the electrical signals from the first and second optical sensors 14, 16 as described above. When the input device 140 is in the idle power mode, on the other hand, the processing system 18 discontinues processing the electrical signals from the first and second optical sensors 14, 16. In this way, erroneous user interface control signals that otherwise might be produced due to the lack of sufficient lighting by the light source 12 may be avoided.

Other embodiments are within the scope of the claims.

What is claimed is:

1. An input system, comprising:
a light source illuminating a first scene that changes in response to a first user input and a second scene that changes in response to a second user input;
a first optical sensor that has a first field of view of the first scene and that produces first electrical signals in response to light from the light source in the first field of view;
a second optical sensor that that has a second field of view of the second scene and that produces second electrical signals in response to light from the light source in the second field of view; and
a processing system that respectively produces first and second user interface control signals from the first and second electrical signals.

2. The input system of claim 1, further comprising a movable member that moves in response to the first user input, wherein movement of the movable member changes the light in the first field of view.

3. The input system of claim 2, further comprising an encoder that modulates light from the light source in the first field of view with information encoding movement of the movable member.

4. The input system of claim 3, wherein the first optical sensor produces the first electrical signals in response to the modulated light.

5. The input system of claim 3, wherein the first optical sensor comprises a first optical detector and a second optical detector that respectively produce from the modulated light first and second quadrature signals that are out of phase with respective to each other.

6. The input system of claim 2, wherein the movable member comprises one of a rotatable wheel, a slidable slider, a rotatable ball, a movable stylus, a movable stick, and a movable button.

7. The input system of claim 1, wherein the second optical sensor captures images of light from the light source reflecting off a surface in the second field of view.

8. The input system of claim 8, further comprising a processing system that produces the second user interface control signals from differences between different images captured by the second optical sensor.

9. The input system of claim 1, further comprising at least one optical element that directs light from the light source toward the first field of view.

10. The input system of claim 1, further comprising at least one optical element that directs light from the light source toward the second field of view.

11. The input system of claim 1, further comprising an optical port through which light from the light source passes to reach the second field of view.

12. The input system of claim 1, further comprising a housing containing the light source, the first optical sensor, and the second optical sensor, wherein the first scene is within the housing and the second scene is outside the housing.

13. The input system of claim 1, wherein the processing system the light source intensity is reduced when the processing system determines that the electrical signals of at least one of the first and second optical sensors are not needed for the production of a user interface control signal.

14. The input system of claim 1, further comprising a computer coupled to the processing system and operable to control a graphical user interface in response to the first and second user interface control signals.

15. An input system, comprising
a housing containing a light source, a movable member, an encoder, a first optical sensor, a second optical sensor, and a processing system, wherein:
the encoder modulates light from the light source with information encoding movement of the movable member;
the first optical sensor receives light from the light source modulated by the encoder and produces first electrical signals in response to the received modulated light;
the second optical sensor captures images of light from the light source reflecting off a surface outside the housing and produces second electrical signals in response to the captured images; and
the processing system respectively produces first and second user interface control signals from the first and second electrical signals.

16. An input method, comprising:
producing light from a source illuminating a first scene that changes in response to a first user input and a second scene that changes in response to a second user input;
producing first electrical signals in response to the light illuminating the first scene in a first field of view;
producing second electrical signals in response to the light illuminating the second scene in a second field of view; and
respectively producing first and second user interface control signals from the first and second electrical signals.

17. The method of claim 16, further comprising modulating the illuminating light from the first field of view with information encoding movement of a movable member in response to the first user input.

18. The method of claim 17, wherein the first user interface control signal is produced in response to the modulated light.

19. The method of claim 16, wherein the producing of the second electrical signal comprises capturing images of the illuminating light reflecting off a surface in the second field of view.

20. The method of claim 19, wherein the producing of the second user interface control signal comprises determining differences between different images of the illuminating light reflecting off the surface in the second field of view.
